(19) United States
(12) Patent Application Publication
(10) Pub. No.: US 2025/0163766 A1
(43) Pub. Date: May 22, 2025

(54) METHOD FOR USING DRILLING FLUID IN DRILLING OPERATIONS, DRILLING FLUID AND ITS USE

(71) Applicant: PETRÓLEO BRASILEIRO S.A. – PETROBRAS, Rio de Janeiro (BR)

(72) Inventors: Fabio FABRI, Santos (BR); Jose Robelio LIMA DE ARAUJO, Rio de Janeiro (BR); Leila Cibele Da Costa MUNHOZ, Santos (BR); Leonardo SILVA DE ALMEIDA, Rio de Janeiro (BR)

(21) Appl. No.: 18/938,628

(22) Filed: Nov. 6, 2024

(30) Foreign Application Priority Data
Nov. 19, 2023 (BR) 1020230242375

(51) Int. Cl. E21B 21/00; C09K 8/10; C09K 8/12; E21B 7/04; E21B 33/14; E21B 44/00; E21B 49/00

(52) U.S. Cl. CPC E21B 21/003; C09K 8/10; C09K 8/12; E21B 7/04; E21B 33/14; E21B 44/00; E21B 49/005

(57) ABSTRACT

The present disclosure refers to a method for using drilling fluid in drilling operations in the presence of saline lithology, with the aim of optimizing drilling without damaging the caliper and thus improving well construction conditions. Additionally, the present disclosure relates to an undersaturated low salinity drilling fluid, thus showing a potential to reduce the risks of column clogging due to salt precipitation and casing clogging, as it improves cleaning conditions inside the well, as cuttings and possible salt-generated beds are solubilized. The aforementioned drilling fluid will be applied in the construction of wells with potential gains in the disciplines of drilling fluids, directional tools and casing and cementing.

### FIELD OF THE DISCLOSURE

The present disclosure refers to the field of oil well construction, more precisely in the fields of drilling and well completion, and the disclosure describes a method for the use of drilling fluid in drilling operations, having application in the construction of wells with potential gains in the disciplines of drilling fluids, directional tools and casing and cementing.

### BACKGROUND OF THE DISCLOSURE

During the construction of offshore oil wells, at the step where drilling is expected to cross significant sections of salts, it is desirable to keep the well diameter close to the diameter planned for the phase, that is, close to the drilling bit diameter or the bit and reamer assembly. Compliance with this premise is based on the fact that the erosion due to dissolution of the well walls affects both the drilling performance of the phase and can structurally compromise the well, either immediately by preventing isolation of the phase, or impairing the cementing operation, that is, at some point in the productive life of the well where the combination of salt creep in a poorly cemented section causes the rupture of the casing due to the poor distribution of radial loads, thus causing a critical failure of the barriers solid set. Restricting this dissolution depends directly on the drilling fluids discipline, since fluids with low affinity to the salts present in the lithological layer in which they are drilled are used to avoid excessive erosion.

Organic-based drilling fluids are widely used due to the low solubility of the salts, but as they are an emulsion, the aqueous phase allows partial dissolution. Fluids also present risks when confined because, due to the thermal increase (Annular Pressure Build-up—APB) prescribed and/or associated with the creep mechanism presented by saline rocks in confined annuli, they can promote their undesirable bubbling on the seabed due to integrity failures of shallower barriers, which main impact is the environmental one. They are also more susceptible to column trapping due to salt creep, requiring the use of heavy weights, being more dependent on logistics as they are prepared at onshore stations, in addition to being expensive.

Currently, two types of drilling fluids are used: non-aqueous base fluid—FPBNA (Fluido de Perfuração de Base Não Aquosa) and aqueous base fluid with saturated phase—FPBA (Fluido de Perfuragso de Base Aquosa com Fase Saturada). FPBNAs comprise an alpha olefin emulsion, and the internal phase is a brine. As the organic phase is the continuous phase, in direct contact with the well walls, the low solubility of salts in organic solvents would be the reason for its use, as the diameter would be kept close to the planned one. However, the internal aqueous phase, despite of having high salinity, is capable of dissolving different saline rocks, causing erosion of these layers, generating stops and the collapse of rocks that make drilling difficult. Difficulties in lowering the casing, without being able to advance to the final depth of the phase, means that the isolation of this section is not guaranteed. Preparation takes place in onshore stations having a high cost and, even reducing the aqueous phase content until obtaining a 100% organic fluid, it adds more costs and logistical dependence for input delivery. Another disadvantage is that the fluid dissolves less in halite, which makes the drilling more susceptible to saline creep, and events of column trapping due to the closure of the well diameter are more common. It requires the use of high weights compared to other types of fluids to contain the closing speed, both to avoid column trapping and the lowering of the casing that isolates the salt layers. Ultimately, the confined fluid may suffer the effects of thermal growth and, associated with the pressure increase in the closed chamber (saline APB), may cause the rupture of more superficial barriers, allowing the fluid to bubble on the seabed, which is undesirable from an environmental point of view.

The alternative is to use a water-based fluid (b), saturated FPBA, which, due to the common ion effect, prevents erosion of the walls by dissolving the saline rock. In terms of confined annulus, as it presents low compressibility and thermal expansion effects, it ends up mitigating saline APB problems and in case of rupture, its leakage into the seabed does not have major impacts. Under bottom conditions the fluid is not fully saturated, and as its composition contains only one type of salt, it does not prevent the dissolution of different salts. In the presence of halite, the dissolution effect is better controlled, so the annulus presents a slight dissolution, which is favorable as it reduces the risk of column trapping due to the effect of salt creep. However, the incorporation of different salts forces the displacement of the species equilibrium solubilized in the fluid which, upon reaching saturation, precipitate salts. It's very common in saturated fluids to coexist with fine salt typical of recrystallization, especially in sections with lower temperatures. The variation in thermal amplitude forces the precipitation of sodium chloride crystals and it causes clogging of elements, formation of a bed and false bottom, making it impossible to install the universal sealing assembly—CVU (Conjunto de Vedação Universal) (Universal-to-metal (CVU) casing pack-off).

The use of saturated aqueous fluids is, then, intensified, and the premise for minimizing dissolution is the common ion effect, mainly chlorides (sodium chloride is used in the preparation). The fluids have a simplified composition, are less expensive compared to organic-based fluids and can be prepared in offshore. However, under the temperature and pressure conditions at the well bottom, they are not necessarily saturated, in addition to the natural stratification of salts present causing that different salts, with different solubilities, be incorporated into the fluid, promoting localized dissolutions and, due to temperature variations, they can promote reprecipitation effects, which are solids that remain in the well, leaving a deficient cleaning that can cause clogging in the well bottom assembly (Bottom Hole Assembly—BHA) and lining shoes, covering with false bottom and making it impossible to install and energize the CVU.

### PRIOR ART

The document on behalf of Lomba et al., entitled “Lessons Learned in Drilling Pre-Salt Wells with Water Based Muds”, analyzes the results of two cases in the Brazilian pre-salt region where salt zones were drilled using aqueous fluids. It presents preliminary physical studies on the effects of salinity and viscosity of an aqueous drilling fluid on the dissolution of salt cores, aiming to support the decision to drill these wells with saturated water-based muds (FPBA). As a note, these studies were used to develop the software cited in the document on behalf of Folsta. et al., entitled “Predicting Salt Leaching During Drilling and Cementing Operations”.

At that time of pre-salt development and as the author mentions, the design of the fluid for drilling saline zones focuses on obtaining a well-calibrated section (in gauge) to prevent its collapse with the possible widening of the well walls, destabilizing the layers of different salts, with different behaviors (solubility and creep). There was a consensus in the industry that in order to achieve robustness and safety in the execution, it would be necessary to use non-aqueous drilling fluids to minimize the interaction between the fluid and the formation, wherein the operator opted to choose an n-paraffinic based fluid.

The tests sought to present inputs to justify the change of model, showing that by optimizing the formulation of the aqueous fluid it was possible to obtain similar results and this would be achieved by using saturated fluids (high salinity) to minimize the possible interaction between fluid and formation and always paying attention to the weight of the fluid (so as not to affect the control of salt creep).

The work presented by Lomba et al. differs from the method proposed in the present disclosure, since it does not advocate the use of a sub-saturated fluid, since, as the author claims, it would not be able to minimize the interaction with the saline formation. It should be noted that such a recommendation also is presented in the work on behalf of Whitfill et al., entitled Drilling Salt—Effect of Drilling Fluid on Penetration Rate and Hole Size.

In case #1 of Lomba et al.'s work the drilling of a section with the presence of shales (post-salt) and salts is discussed, and the use of aqueous and saturated fluid is proposed, in which the minimum weight would be 9.9 lb/gal within the upper limit (shoe fracture) expected for the phase, but during execution, this limit was found to be lower, forcing the fluid to be diluted to lower weights and consequently leaving the fluid undersaturated. This fact was not a problem for drilling the shale section, but upon entering the saline layer, the incorporation of salt caused the weight of the fluid to increase uncontrollably, exceeding the upper limit and thus causing the weakening of the previous shoe, which caused circulation losses, making it impossible to continue the phase, which was only completed after replacing the fluid with a non-aqueous, lightweight fluid, within the upper limit of the phase.

The purpose of the present disclosure does not apply to case #1 because, being a specific case, it is not a recommended practice. In the present disclosure, the incorporation of salts primarily originating from drilled cuttings is a natural process anticipated in the planning, and the upper weight limit for the phase is not a constraint for the strategy. It is observed that it is possible to drill combined sections of shale (post-salt) with salt through the proposed disclosure, as long as the weight planning (which considers the incorporation of salt) remains within the upper limit of the phase.

In the Lomba et al. Case #2 again it is proposed a saturated fluid (table 6—“saturated NaCl Brine, as needed”). The upper limit herein does not limit the use of saturated fluid with high weight (11.5 lb/gal) and the analysis of the post-drilling caliber of the phase showed that it was close to the drill bit diameter (in gauge) in the halite sections (predominant salt), but highlights that the section with the presence of other salts became quite widened, which is already common knowledge since the saturated fluid in NaCl does not contain the dissolution in sections of stratified salts, even non-aqueous fluids (which aqueous phase is a NaCl brine).

In the method disclosed in the present disclosure, the fact that drilling begins with an undersaturated fluid is not a limiting factor. It is worth highlighting what was observed in a field study and observed according to FIG. 1 which, even contradicting simulator data, after drilling the beginning of the phase with low salinity fluid, the halite sections remained close to the drill diameter (in gauge) even with fluid not saturated in NaCl. Another advantage of the undersaturated fluid to highlight is that it avoids the reprecipitation of salts that is common in saturated systems subjected to large temperature variations, and that it prevents problems with salt deposition in systems sensitive to dirt (for example, universal sealing assembly—CVU, or even blockages of the bottom hole assembly—BHA) during column maneuvers.

The work on behalf of Medeiros, entitled “Estudo de fluidos de perfuração aquosos: proposta de uma metodologia para caracterização” is a bibliographic review on optimization of fluid properties based on common additives and characterization methods to obtain best results. A difference between the work and the present disclosure is that the results were used to propose an aqueous fluid formulation with the aim of drilling clay formations, wherein the method object presented in the proposed disclosure is to drill predominantly saline formations.

Furthermore, Medeiros comments on the salinity role. In the work, the author highlights the importance of saturation to prevent excessive widening, treating this as a system compatible with the salt to be drilled, and proposes an alternative for drilling short sections of salt, where a slightly undersaturated system could result in a highly controlled dissolution rate and emphasizes that this alternative promoted a slight widening to prevent the closure of the salt due to its creep (plastic deformation). Unlike Medeiros' analysis, the present disclosure aims to drill large areas of salt with undersaturated systems in any proportion. In the well studied, the system reached saturation approximately 540 m after the start of drilling in the saline section and the diameter of the well in this section, in the halite layers, remained close to the diameter of the drill bit, again showing that the rheology is capable of containing the dissolution of the wall comprising the predominant species in the phase, and that what is incorporated into the fluid is mainly the cuttings generated by the advancement of drilling.

Document US2019270925A1 aims to develop a fluid for reservoir drilling, that is, permeable zones carrying hydrocarbons, where a fluid that causes as little damage as possible is desirable, especially when the reservoir has low permeability (less than 0.1 mD). To contain this damage, the introduction of an additive (sodium silicate) into the composition generates a plaster (filter cake) very thin and easy to remove, restoring the original permeability of the formation. The additive can be used regardless of the fluid base (aqueous or non-aqueous).

The main difference between the method proposed in the present disclosure and this document is that the document focuses on drilling non-reservoir zones, and predominantly comprising large saline extensions with aqueous fluid and low salinity. The salt layers are the reservoir caps (they are above the reservoir and form a type of enclosure that prevents the migration of hydrocarbons to the surface) and therefore do not present permeability or even porosity, so the introduction of an additive such as sodium silicate makes no difference, as there is no formation of plaster in front of the salt wall, as there is no filtration of fluid into porous areas (salt is a totally “plastic” formation). The advantage of the proposed method is to reduce costs with fewer additives, simplifying drilling and obtaining results similar to a fully saturated fluid.

Document WO2013096108A1 presents a drilling fluid formulation for drilling saline extensions using an aqueous-based fluid containing 5% to 95% by volume of a non-aqueous and/or non-oil component. One aspect of the document is that by varying the concentration of a non-aqueous component that is assumed to be above 50% in the composition, although miscible in water, it should transform the fluid in a non-aqueous drilling fluid and with properties distinct from aqueous fluid. The aforementioned document proposes that the addition of the additive is capable of reducing the chemical activity of water (or Aw), which would be the ability of water to associate with various non-aqueous and solid constituents. Salts are components that, when added to the fluid, promote a reduction in water activity, and this leaves less “free” water, available to dissolve salts and other solutes until saturation is reached.

The aforementioned document highlights that in situations where an operator is drilling a section that passes through salts, it is important for the fluid to be close to saturation, saturated or supersaturated (salt in suspension) to inhibit or prevent the dissolution of salt on the well walls. To achieve this objective, it cites the discovery that a non-aqueous and non-oleaginous component to the aqueous fluid was able to reduce the water activity and thus reduce the amount of salt required to reach the equivalent of its saturation. This is how the salt is replaced by the new compound to obtain the same effect.

The difference between the method proposed in the present disclosure and the aforementioned document is that there is no insertion of a new additive into the composition, on the contrary, it reduces the concentration of salt in the initial formulation and saturation is reached naturally during drilling, without compromising the quality of the well in terms of widening the salt walls. It represents a cost reduction because including a new additive means making the system more expensive and creating a dependency on proprietary systems. This methodology does not focus on water activity, on the contrary, it increases activity, but it is evident that viscous systems in the well conditions in which the method is to be applied are sufficient to contain saline dissolution by simply reducing the diffusion of salt from the wall to the fluid, with the main contributor to the increase in salinity being the cuttings generated by drilling, which are in greater contact with free water within the upward flow from the bottom of the well to the surface.

### SUMMARY OF THE DISCLOSURE

The present disclosure aims to propose a method for the use of drilling fluid in drilling operations, in the presence of saline lithology, with the aim of optimizing drilling, without damaging the caliper and thus improving well construction conditions. Additionally, the present disclosure discloses a low salinity drilling fluid (undersaturated), thus showing a potential to reduce the risks of column clogging due to salt precipitation and casing clogging, as it improves cleaning conditions inside the well, as cuttings and possible salt beds generated are solubilized.

### BRIEF DESCRIPTION OF THE FIGURES

FIG. 1 describes a representation of the logging curves in a well in the saline section drilled with an undersaturated fluid and the treatment of the resistive profile to obtain the average caliper of the well by depth, where (a) refers to the uncertainty of the eccentricity, in inches; (b) eccentricity ratio (dimensionless measurement); (c) eccentricity or deviation in relation to the center of the well, in inches; (d) geological monitoring profile (PAG—Perfil de Acompanhamento Geologico) (or striplog) contemplating the interpretation of trough samples and profiles; (e) formation resistivity, in ohm·m; (f) uncertainty of the well diameter measurement in inches; (g) well diameter, in inches; (h) measured depth, in meters; (i) baseline representing the phase/drill diameter (14¾″ inches) and (j) highlighting in widened sections with the presence of salt intercalations, other than halite according to an embodiment of the disclosure. The recorded measurements show an important indicator of widening caused by localized dissolution in different salts, representing the heterogeneity of the salt column, and the results obtained in the model well (Well A). It is interesting to note that in the halite sections there is no significant dissolution, nor the formation of a typical dissolution cone indicating that the fluid is saturating as drilling progresses.

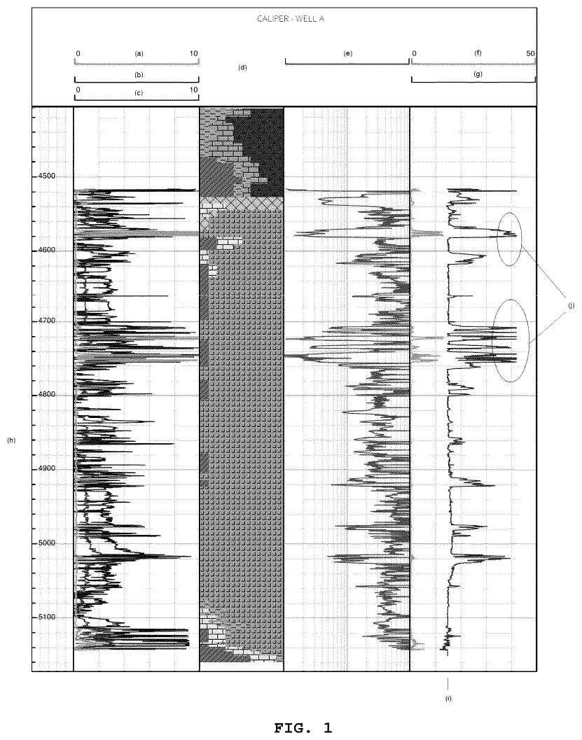

### DETAILED DESCRIPTION OF THE DISCLOSURE

The present disclosure refers to a method for using drilling fluid in drilling operations in the presence of saline lithology, with the aim of optimizing drilling without damaging the caliper and thus improving well construction conditions. The aforementioned method comprises the following steps:
during the planning and design step:
(a) receiving details of the salt, with its stratigraphic composition;
(b) evaluating the upper limit of the phase (fracture gradient at the depth of the last casing shoe) and the weight required at the end of the phase, if the same can be met within the consolidation strategy by incorporating gravels;
(c) based on the well diameter, estimating through a mass balance the desired initial salinity and the estimated depth of fluid saturation, as well as defining the initial and final weight after saturation;
(d) confirming with the cementing project which final well extension is necessary for the fluid to be close to saturation in order to finally define the density and initial design salinity;
(e) confirming with simulation and the reported stratigraphy whether the mass balance prediction is reproduced through temperature balance and salt balance.
during operation:
(f) preparing fluid according to the suggested composition, observing salinity and initial weight;
(g) performing a formation integrity test to assess whether the final weight of the well is within the planned range, making any necessary adjustments during drilling (suppressing solid consolidation, for example);
(h) replacing well fluid and start drilling;
(i) monitoring the evolution of the weight and salinity of the fluid during drilling, noting the increase in chlorides, sodium, potassium, calcium, and magnesium in the fluid;
(j) performing weight control with undersaturated fluid or, if necessary, ensuring a calibrated final section but with weight within a certain range, using saturated and light fluid;
(k) in case of column trapping, the undersaturated fluid itself can be temporarily circulated, but more effectively, a saline fluid that is undersaturated and has no viscosity, or even fresh water, can be used to release the column;
(l) at the end of drilling, a combination of a low rheology fluid followed by a viscous and low salinity fluid that, when combined, will promote the suspension of gravels that may have formed a bed in inclined sections and that will be dissolved during the cleaning flow. Column rotation can also be combined to aid removal; and
(m) maneuvering the column and, if possible, providing a memory profile in LWD during removal, preferably without circulation, to measure the calibrated well extension (drill diameter).

A typical composition of the aqueous fluid used to drill predominantly salt lithologies is shown below in Table 1. These are reference values and may vary, including changes in additives within the same function (for example, replacing glutaraldehyde with triazine, or barytes with limestone)

TABLE 1

Concentration

| | | | |
|---|---|---|---|
| Additive | Function | lb/bbl | g/l |

| | | |
|---|---|---|
| Water | Continuous | 87.6-92.2% v/v |
| | Phase | |

| | | | |
|---|---|---|---|
| Sodium | Salinity | 0-96.7 | 0-276.4 |
| chloride | Donor | | |
| Sodium | Calcium and | 0.5-1.5 | 1.43-4.29 |
| bicarbonate | Magnesium | | |
| | Controller | | |
| Xanthan Gum | Viscosifier | 1.5-2.5 | 4.29-7.15 |
| Polyanionic | Filtrate | 0-1.0 | 0-2.86 |
| cellulose | Reducer | | |
| Caustic Soda | Alkalizing | 0.1-0.3 | 0.29-0.86 |
| Glutaraldehyde | Bactericidal | 0.1-0.3 | 0.29-0.86 |
| Antifoaming | Antifoaming | 0-0.3 | 0-0.86 |
| with silicone | | | |
| Baryte | Thickener | 20-90 | 57-257 |

The common sense for drilling these salt sections is that to prevent the well diameter from increasing beyond that designed by the dissolution of the salt, the fluid should be saturated, that is, use the maximum concentration of a salinity donor (typically sodium chloride or calcium), with the fluid viscosity being sufficient to prevent the dissolution of the well walls, or at least that this effect should be controlled satisfactorily, allowing us to start drilling the saline section with a fluid where the concentration of the salinity donor is low.

During drilling, the fluid incorporates salts from the drilling itself, generated by the cuttings that are within the ascending flow of the fluid. These (gravels) end up becoming the “salinity donors” and dissolve (preferably compared to the walls) during the return flow to the rig, and this generates the advantages mentioned, such as savings in fluid preparation, drilling with less solids suspended in the fluid (clean environment) and lower risks of gravel beds (clogging, “false bottom”) and an unexpected effect but that improved drilling performance (possibly the jetting of the drill with the unsaturated fluid generates a localized dissolution and cleans the drill inserts, increasing its efficiency).

The weight of the initial composition can also vary depending on the initial concentration of the salinity donor, commonly weights of 10.3 lb/gal (1.23 g/cm3) to 10.5 lb/gal (1.26 g/cm3) and naturally increases as it dissolves the gravel generated by the advancement of drilling in the saline section.

As previously mentioned, the fluid commonly used is polymeric FPBA where the difference lies in the initial salinity of the fluid, which can range from 0 mg/l up to close to saturation, which is 311,000 mg/l of sodium chloride. Other salts such as calcium chloride can be used, varying only the types of polymers that will be used to viscosify the fluid. As the main salt present in the formations is halite, the reference used is sodium chloride. Therefore, to observe the desired effect, it is recommended to leave the salt content, in this case in terms of chlorides, below the sodium chloride saturation, as it is the salt that can precipitate more quickly with the increase in salinity. Fluid exchange can be performed without changes to the common procedure, even when cutting cement and metal elements.

Tests carried out in the field demonstrated that being below saturation did not reduce or make it impossible to perform formation integrity tests—FIT or absorption tests—LOT. Drilling initially occurs without observing the return of cuttings consistent with the drilling rate, due to the solubilization of salts.

It is observed an increase in volume, which may lead to a false interpretation of influxes, but it is an expected behavior due to the incorporation of salt into solution. It is desirable to monitor the fluid properties more frequently to understand the process, such as increases in salinity, weight, pH, and volume of the active system.

Monitoring screens by observing the return of cuttings is also an indication of the moment in which the fluid becomes saturated. Naturally, this incorporation promotes saturation over time, it results in a natural increase in the weight of the fluid, and it is possible to calculate at what depth it is expected through a simple mass balance of the cylinder incorporation cut from saline rock into the drilling fluid.

If a minimum weight is required at the end of the phase, it is possible to dimension the initial weight of the fluid using thickeners. The predictability of the lithological layers, flow rate used, and different salts present will promote saturation, or not, at depths greater than estimated, but this may be a desirable effect, since a cleaner environment without gravel is desired. In the event of column trapping, the process already used involves the displacement of freshwater mattresses without viscosity, to promote the salt dissolution, which, combined with efforts in the column, will release it.

As the fluid at the end of drilling may be saturated, there is always the possibility of beds generated from gravel with recrystallized salt, or even in suspension in the fluid and which were not removed by the solids separation system, so in these cases a mattress of undersaturated fluid can be used again combined with low rheology fluids to resuspend the gravel and allow its dissolution in this mattress.

### EXAMPLE OF THE DISCLOSURE

It is essential to understand how the salt dissolution behavior due to the use of undersaturated fluid affects the well diameter, since excessive break-in generates stops that make it difficult the lowering of the phase casing, may expose the previous casing shoe and compromise its integrity, in addition to how the quality of the phase casing cementing is compromised due to the caliper increase in the section where the cement is considered an important barrier to isolate the reservoir. It is known that viscosity is a preponderant factor in delaying erosion by dissolution and corroborating the drilling strategy with undersaturated fluid.

In a real case, when drilling the 12¼″×14¾″ phase, the strategy was applied on a contingency basis due to the delay in the supply of brine. Starting from the dilution of the concentrated fluid with seawater, 11.6 lb/gal of an undersaturated aqueous base fluid was used (initial salinity of 143,000 mg/L in chlorides). As the fluid was lighter than expected (projected to be 12.0 lb/gal), it was considered to start drilling the phase without performing weight control, incorporating salt until the fluid reached saturation.

Drilling of the phase using this fluid occurred without abnormalities. The well diameter obtained with resistive profiling was, on average, 17 in (in the well enlarged to 14 in ¾″), and an average diameter close to 15″ in the intervals with halite. At the beginning of drilling, no return of salt gravels was observed in the screens, indicating that they were constantly solubilized as drilling progressed. This indicates that the greatest incorporation of salt occurs due to the contact of the gravel with the fluid and not so much with the walls of the well.

Due to the rheological model (layered flow), it is expected that the fluid near the wall becomes more saturated and this hinders the diffusion of salt from the annulus to the fluid, while the gravels, with greater contact within the upward flow, are the greatest contributor to the incorporation of salt into the fluid composition. It would then be expected that salinity and weight would increase along the drilling, becoming 100% saturated before entering the reservoir. If the incorporation of salt occurred only through the dissolution of the annulus (well wall), the forecast indicated that the fluid would be saturated in the first 160 m drilled (halite package), however it only occurred after 542 m drilled.

Considering this extension of the salt column as entirely halite (NaCl) and analyzing the circulating volume and initial weight of the fluid, we can consider that only the dissolution of the gravels by the cut cylinder would be able to saturate the fluid, increasing the weight up to 12.2 lb/gal. In fact, the salinity reached saturation with a lower weight (11.8 lb/gal), which corroborates the hypothesis. Deviations in weight can be justified due to stratification of the salt column and also by a larger volume of fluid prepared on the surface.

Thus, it is observed that the observed salt dissolution behavior increases the confidence of starting the saline phase drilling with an undersaturated fluid.

Operationally, reducing dependence on a saturated fluid represents a small potential for saving the final price of the fluid (reduction in price/bbl.), but the big gain is in minimizing non-productive time (non-productive time—NPT), reducing rig downtime and thus optimizing the operational cost of well construction. Waiting time to receive or replace the input for preparing the fluid (brines), as well as relieving the supply chain. Controlled dissolution of the walls allows better control over the salt flow, and avoids column and casing trapping, reducing fishing time. With creep better managed, it is possible to work with lower fluid weights, again reducing stress on the supply chain of chemical additives (thickeners) and direct costs in the fluid produced, but it has also presented a gain in drilling performance, allowing drilling to be done faster. Still on the subject of lower weight, it also mitigates the risk of fracturing formations (reaching upper collapse or weakening the previous casing shoe).

During the cementing operation, again the weight is lower as it reduces the surge effect on the casing lowering which can induce fractures, and the equivalent density of drilling fluid (Equivalent circulating density—ECD) during paste circulation, minimizing the risk of loss of circulation during cementation, performing a much more controlled and reliable operation. Dissolution also ensures greater comfort in obtaining the minimum thickness of the cement sheath. The undersaturated fluid reduces the risk of salt precipitation, which occurs in a saturated environment from the start. It shows the potential to reduce the risk of column clogging due to salt precipitation and casing clogging, as it improves cleaning conditions inside the well, as cuttings and possible salt beds generated are solubilized.

### APPLICABILITY OF THE DISCLOSURE

The most significant area of application is the well construction/drilling, with potential gains in the disciplines of drilling fluids, directional tools and casing and cementing.

### Expected Advantages

### Health/Security

Increases reliability in coating and cementing operations by generating a cleaner and more controlled environment. As it is an aqueous fluid, it presents less risk in the event of leaks, as it is a fluid that is annealed for disposal.

### Economic/Productivity

Reduces direct costs of fluid and supply chain (logistics), minimizes the risk of tool trapping caused by clogging and salt creep. It increases the drilling performance of the phase and reduces the risk of non-productive times, generating a direct reduction in well construction costs.

1. A method for employing drilling fluid in drilling operations, the method comprising:
(a) receiving details of a salt, with its stratigraphic composition;
(b) evaluating the upper limit and weight required at an end of a phase;
(c) based on the well diameter, estimating through a mass balance and desired initial salinity, estimated depth of fluid saturation, and defining initial and final weight after saturation;
(d) confirming with a cementing project which final well extension is necessary for the fluid to be close to saturation;
(e) confirming with simulation and the stratigraphic composition provided whether a mass balance prediction is reproduced through temperature balance and salt balance;
(f) during operation, preparing fluid according to suggested composition and observing salinity and initial weight;
(g) performing a formation integrity test to assess whether the final weight of the well is within the planned range, and making any necessary adjustments during drilling;
(h) replacing well fluid and start drilling;
(i) monitoring the evolution of the weight and salinity of the fluid during drilling, noting the increase in chlorides, sodium, potassium, calcium, and magnesium in the fluid;
(j) performing weight control with undersaturated fluid and, if necessary to ensuring a calibrated final section with weight in a certain range, use saturated and light fluid;
(k) temporarily circulating the undersaturated fluid itself, using an undersaturated saline fluid with no viscosity, or even fresh water to release the column;
(l) at the end of drilling, using the combination of a low rheology fluid followed by a viscous and low salinity fluid that, when combined, promotes suspension of cuttings when forming a bed in inclined sections and to dissolve during the cleaning flow, in which column rotation to aid in removal can be combined;
(m) maneuvering the column and providing a memory profile in LWD during removal, without circulation, to measure the calibrated well extension.

2. A drilling fluid comprising the following components:
from 87.6 to 92.2% v/v of continuous phase, mainly water;
from 0 to 276.4 g/l (0 to 96.7 lb/bbl) of donor salinity, mainly sodium chloride;
from 1.43 to 4.29 g/l (0.5 to 1.5 lb/bbl) of calcium and magnesium controller, mainly sodium bicarbonate;
from 4.29 to 7.15 g/l (1.5 to 2.5 lb/bbl) of viscosifier, mainly xanthan gum;
from 0 to 2.86 g/l (0 to 1.0 lb/bbl) of filtrate reducer, mainly polyanionic cellulose;
from 0.29 to 0.86 g/l (0.1 to 0.3 lb/bbl) of alkalizing agent, mainly caustic soda;
from 0.29 to 0.86 g/l (0.1 to 0.3 lb/bbl) of bactericide, mainly glutaraldehyde;
from 0 to 0.86 g/l (0 to 0.3 lb/bbl) antifoaming, mainly silicone antifoaming; and
from 57 to 257 g/l (20 to 90 lb/bbl) of thickening agent, mainly baryte.

3. A fluid according to claim 2, wherein the weight of the initial composition varies depending on the initial concentration of the salinity donor, from weights of 10.3 lb/gal (1.23 g/cm3) to 10.5 lb/gal (1.26 g/cm3).

4. A method of use of drilling fluid as defined in claim 2, wherein the drilling fluid is used for the construction of wells with potential gains in the disciplines of drilling fluids, directional tools and casing and cementing.
